(19) United States
(12) Patent Application Publication
(10) Pub. No.: US 2011/0085849 A1
(43) Pub. Date: Apr. 14, 2011

(54) COUPLING DEVICE FOR AN ARTICLE HANDLING MACHINE

(75) Inventor: Michele Calzolari, Octeville sur Mer (FR)

(73) Assignee: SIDEL PARTICIPATIONS, Octeville Sur Mer (FR)

(21) Appl. No.: 12/933,385

(22) PCT Filed: Mar. 20, 2008
(86) PCT No.: PCT/IB08/01416

§ 371 Date: Dec. 17, 2010

(51) Int. Cl. F16B 12/10

(52) U.S. Cl. 403/292

(57) ABSTRACT

Device (14) for coupling two adjacent blocks (2, 3) of an article handling machine (1), each provided with an aperture (11), said coupling device (14) being characterized in that it comprises a metallic connector (15) including two sidewise edges (16) by which it is fixed to the blocks (2, 3) along at least part of their respective apertures (11), said connector (15) further including a central arched section (17) which bridges the blocks (2, 3) over an interstice (13) provided therebetween.

### FIELD OF THE INVENTION

The invention relates to a coupling device for interfacing two adjacent blocks of an article handling machine.

### BACKGROUND OF THE INVENTION

Article handling machines are often manufactured in several parts (called blocks) assembled to form a one-piece manufacturing line.

Such a design, called modular design, is satisfactory because it facilitates transportation of the different blocks (which may come from different manufacturing places) to the final destination where the machine is assembled.

Usually, the machine is assembled by welding the different blocks to each other after having aligned apertures therein, through which articles are to be transferred from one block to the adjacent one.

Welding is not quite satisfactory because, under the heat generated by the welding process, the blocks may undergo non reversible distortions at their interface, due to residual stresses. Such distortions may displace the article transferring devices mounted in the blocks, leading to possible machine malfunction.

In addition, certain applications, such as aseptic filling in the container industry, require that the inner volume of the handling machine be isolated from the outer environment to preserve containers from bacteria.

In such a case, the interface between two adjacent blocks should provide tightness in order to avoid air leaks to the inner volume of the machine. As the blocks undergo distortions during their welding, or even during machine operation (e.g. due to vibrations), tightness might be compromised.

There is therefore a need for improvements in coupling devices provided at the interface between adjacent blocks of an article handling machine.

### SUMMARY OF THE INVENTION

It is an object of the invention to provide a coupling device having enhanced reliability.

Accordingly, there is proposed a device for coupling two adjacent blocks of an article handling machine, each provided with an aperture, said coupling device being characterized in that it comprises a metallic connector including two sidewise edges by which it is fixed to the blocks along at least part of their respective apertures, said connector further including a central arched section which bridge the blocks over a interstice provided therebetween.

In a preferred embodiment, the edges of the connector are welded to the blocks. More precisely, each block may be provided with a frame plate an inner edge of which defines at least part of said aperture, each edge of the connector being welded to the edge of said frame plate.

The arched section of the connector, which is e.g. V-shaped and has an angular aperture comprised between 45° and 120°, preferably has its concavity facing the interstice between the blocks.

In a preferred embodiment, the connector is fixed to the blocks all along their apertures.

In addition, the connector is preferably fillet welded to the blocks.

There is also provided an article handling machine comprising at least two adjacent blocks, and a coupling device as disclosed hereinbefore, mounted between the blocks.

The above and other objects and advantages of the invention will become apparent from the detailed description of preferred embodiments, considered in conjunction with the accompanying drawings.

### BRIEF DESCRIPTION OF THE DRAWINGS

FIG. 1 is a partial perspective view showing two adjacent blocks of an article handling machine provided with a coupling device according to the invention.

FIG. 2 is an enlarged sectional view showing the article handling machine of FIG. 1.

FIG. 3 is a sectional view of the article handling machine, taken along line III-III of FIG. 2.

FIG. 4 is an enlarged sectional view showing a detail from FIG. 3.

### DESCRIPTION OF PREFERRED EMBODIMENTS

Turning now to the drawings, there is partly shown an article handling machine 1, e.g. a container handling machine. The machine is modular, and therefore built by assembly of several functional blocks 2, 3 (e.g. for supporting a container feeding unit, a container rinsing unit, a container filling unit and a container capping unit) juxtaposed and coupled by means of removable fixation means such as bolts.

On the depicted example, the blocks 2, 3 are of similar design and both comprise a frame 4 including a table 5 provided with cylindrical barrels 6 for receiving rotary article handling elements such as star wheels pivotally mounted in the barrels 6.

Each block 2, 3 comprises, on opposite lateral sides 7, windows 8 pivotally (or slidingly) mounted on lateral posts 9 of the frame 4, and which an operator may manually open to access the article handling elements inside the machine 1 during setting or maintenance thereof.

Each block 2, 3 further comprises a roof 10 mounted on the lateral posts 9, whereby the table 5, lateral sides 7 and roof 10 together define an inner space wherein the article handling elements are received.

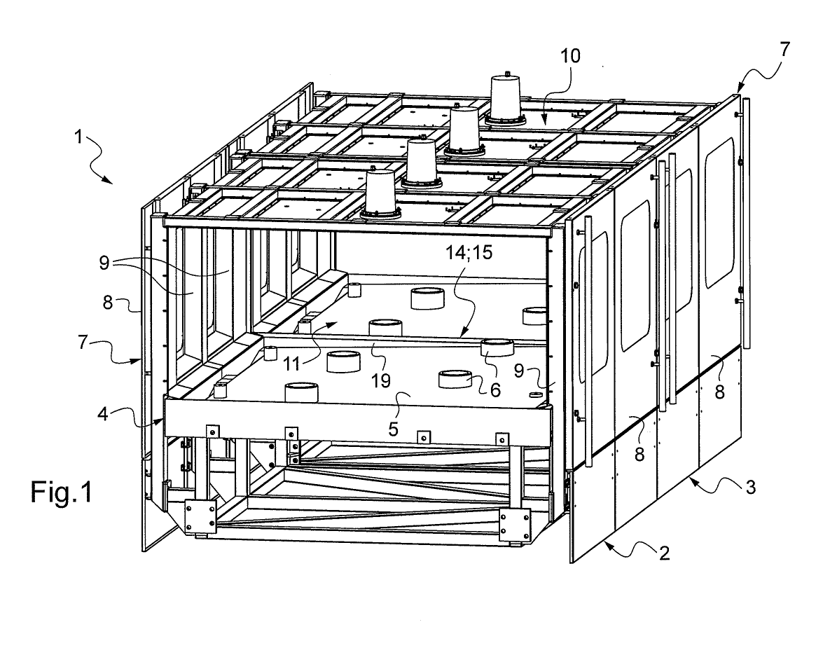

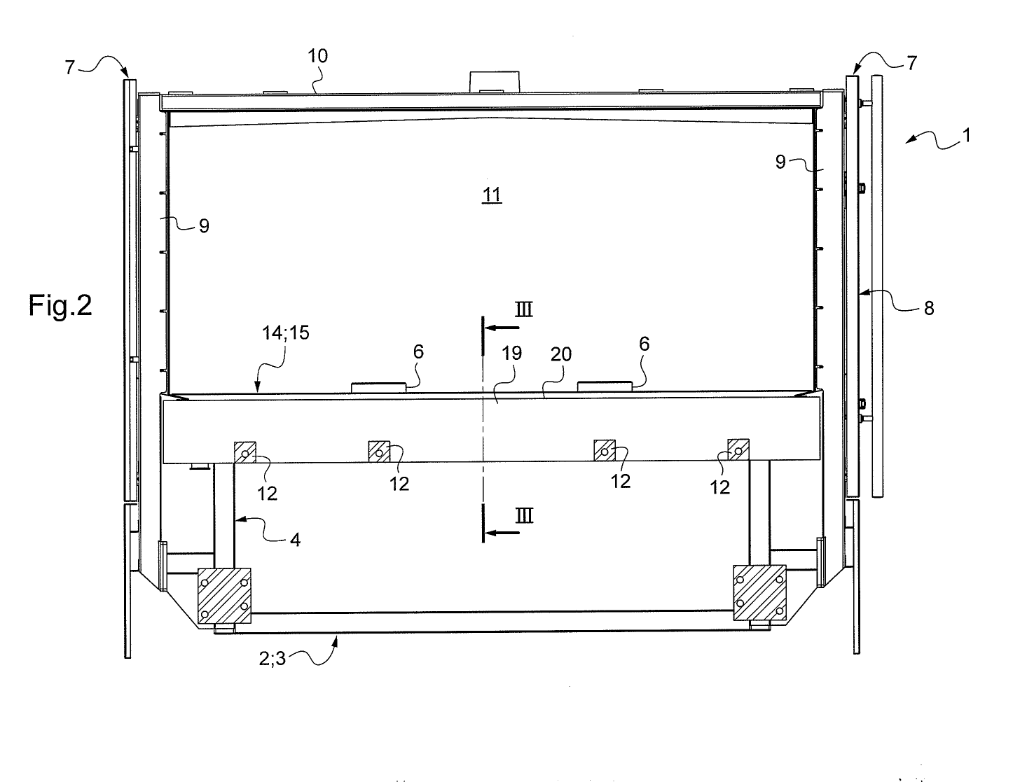

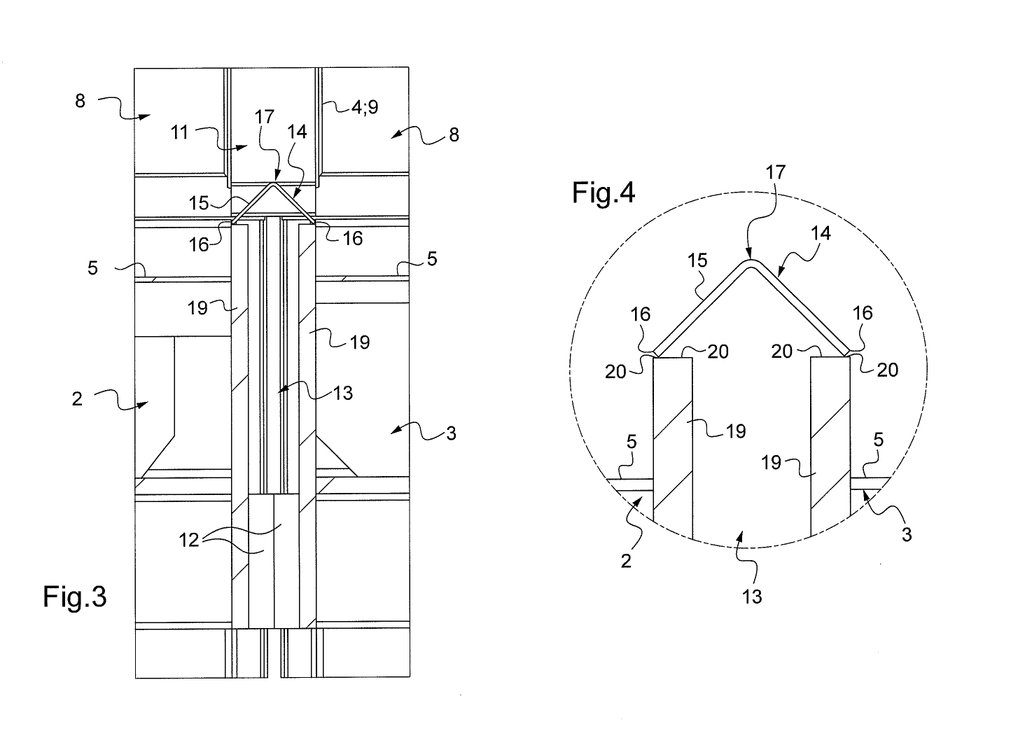

Each module 2, 3 presents, at one end, a transversal aperture 11 of rectangular shape. Once the blocks 2, 3 are assembled, both apertures 11 are coincident, as illustrated on FIG. 1, and together define a common passage for the articles from one block 2 to the other 3. The blocks 2, 3 are fixed to each other by means of fixation bolts inserted in holes provided in respective coupling plates 12 which come into abutment when the modules 2, 3 are assembled. As depicted on FIG. 3, the coupling plates 12 protrude longitudinally from the end of each block 2, 3, whereby an interstice 13 is provided between the facing ends of the blocks 2, 3 when assembled.

As depicted on FIG. 3-4, the machine 1 further comprises a device 14 for sealingly coupling the blocks 2, 3, comprising a metallic connector 15 mounted at the interface of the adjacent blocks 2, 3. More precisely, the connector 15 includes two sidewise edges 16 by which it is fixed to the blocks 2, 3 along at least part of their respective apertures 11, and a central arched section 17 which bridges the blocks 2, 3 over the interstice 13.

In one preferred embodiment, illustrated on FIG. 4, fixation of the connector 15 is achieved through a weld 18 (such as a fillet weld) of the edges 16 of the connector 15 to planar surfaces provided at the ends of the blocks 2, 3. More precisely, as depicted on FIG. 3-4, each block 2, 3 is provided with a frame plate 19 having an inner edge 20 defining at least part of the aperture 11 and to which the connector 15 is welded along an edge 16 thereof.

Although the connector 15 may run along part of the aperture 11, it preferably runs all along the aperture 11, and so does the weld 18.

The connector 15 is formed of a thin metallic profile curved at a predetermined angle and having its concavity turned outwards to face the interstice 13. The connector 15 is preferably V-shaped and has an angular aperture comprised between 45° and 120°. In the depicted example, the angular aperture of the connector 15 is of about 90°. The connector is preferably made of stainless steel, in order to avoid corrosion under wet and acid operational condition.

Accordingly, the connector 15 sealingly couples the blocks 2, 3 so as to avoid any liquid leak at the interface therebetween. As the connector 15 is metallic, the coupling is somewhat rigid, although, depending on the forces exerted at the interface during the mounting, displacement, setting and/or maintenance of the machine 1, the connector 15 may act either as a resilient link capable of absorbing a certain amount of deformation, or even as a frangible link that may break at least partly, should the deformation exceed a given threshold.

The blocks 2, 3 are sealingly assembled as follows.

First, the blocks 2, 3 are placed adjacent to one another, so that the apertures 11 are coincident. The blocks 2, 3 are then fixed to one another by means of fixation bolts inserted in the coupling plates 12. Secondly, the connector 15 is placed at the interface and positioned so as to bridge the blocks 2, 3 over the interstice 13. Thirdly, the connector 15 is fillet welded along its edges 16 to the inner edges 20 of the frame plates 19.

Accordingly, there is provided a coupling device allowing good and reliable performance for sealingly interfacing two blocks in article conveying machines.

Of course, the invention is not limited to the disclosed embodiments. In particular, the skilled person may adapt the size and shape of the connector 15.

1-9. (canceled)

10. Assembly of blocks (2, 3) comprising at least two adjacent blocks (2, 3) each provided with an aperture (11), the assembly comprising a device (14) for coupling the two adjacent blocks (2, 3) said coupling device (14) being characterized in that it comprises a metallic connector (15) including two sidewise edges (16) by which it is sealingly fixed to the blocks (2, 3) along at least part of their respective apertures (11), said connector (15) further including a central arched section (17) which bridges the blocks (2, 3) over an interstice (13) provided therebetween.

11. Assembly according to claim 10, wherein the edges (16) of the connector (15) are welded to the blocks (2, 3).

12. Assembly according to claim 11, wherein each block (2, 3) is provided with a frame plate (19) an inner edge (20) of which defines at least part of said aperture (11), and wherein each edge (16) of the connector (15) is welded to the edge (20) of said frame plate (19).

13. Assembly according to claim 10, wherein the arched section (17) of the connector (15) has its concavity facing the interstice (13) between the blocks (2, 3).

14. Assembly according to claim 10, wherein said arched section (17) is V-shaped.

15. Assembly according to claim 14, wherein said arched section (17) has an angular aperture comprised between 45° and 120°.

16. Assembly according claim 10, wherein the connector (15) is fixed to the blocks (2, 3) all along their apertures (11).

17. Assembly according to claim 10, wherein the connector (15) is fillet welded to the blocks (2, 3).

18. Article handling machine (1) comprising at least an assembly of blocks (2, 3) according to claim 10.
